(19) United States
(12) Patent Application Publication
(10) Pub. No.: US 2025/0148454 A1
(43) Pub. Date: May 8, 2025

(54) METHOD OF TRANSACTION ESCROW USING BLOCKCHAIN WALLETS

(71) Applicant: Coopers Creations Pty Limited, Sydney (AU)

(72) Inventor: Ric B. RICHARDSON, Sydney, New South Wales (AU)

(21) Appl. No.: 18/686,690

(22) PCT Filed: Aug. 25, 2022
(86) PCT No.: PCT/AU2022/051049

§ 371 Date: Feb. 26, 2024

(30) Foreign Application Priority Data
Aug. 25, 2021 (AU) 2021902750

(51) Int. Cl. G06Q 20/36; G06Q 20/38

(52) U.S. Cl. CPC G06Q 20/367; G06Q 20/3829

(57) ABSTRACT

A secure transfer system where a wallet is generated utilising a public and private key pair; whereby the private key of the key pair is encrypted; whereby the public key of the key pair and the encryption key for the private key are given to a party to a transaction; and the other party receives the encrypted private key and the public key of the transfer wallet; where a copy of the encrypted private key, the public key and the encryption key used to encrypt the private key are placed in storage. Also described is a multi sig implementation.

### TECHNICAL FIELD

The present invention relates to a system for the controlled storage and release of data as between three entities.

More particularly but not exclusively it relates to electronic wallets and, more particularly although not exclusively, to electronic wallets related to escrow systems associated with those wallets.

### BACKGROUND

The ability to escrow funds in transactions is well known in the art. In the cryptocurrency field crypto currency exchanges typically fulfill the role of arbiter of transactions by supplying a formal framework for verifying the identity of exchange members, their bank accounts and supplying services to ensure that buyers and sellers of crypto currencies have a reasonable assurance that the other party in a transaction will fulfill their obligations in an agreement to buy or sell.

This is particularly important in the case of blockchain transactions because once crypto currencies are deposited into a specific crypto wallet, it is only the possessor of the private key of that wallet that can retrieve or otherwise direct the contents of that wallet. This characteristic of the blockchain makes it very reliable as a store of digital value but also makes it impossible to claw back funds that have been accidentally sent to the wrong account or where one of the parties does not fulfill their agreed obligation. For example this could be a situation where a person decides to buy crypto currency from a seller using fiat currency and the seller transfers the crypto to the buyer's crypto wallet but never pays the full fiat payment. There is no recourse.

Informal services are available to offer escrow capability for crypto transactions, but typically involve a percentage of the transacted amount and are expensive. Additionally, the funds are transferred to the escrow services accounts for both the crypto currency and fiat funds, and once verified the funds are redistributed to the parties and the transaction completed.

This process is further complicated since the parties typically need to complete identity verification and funds verification for the escrow service to satisfy itself as to the veracity of the two parties before commencing the escrow process.

Technically, an alternative escrow arrangement is possible with crypto currencies where a crypto wallet itself can be the medium of escrow rather than the crypto funds. In this arrangement rather than escrowing funds with the crypto account or wallet of an escrow service, the service could simply supply a wallet and to the crypto selling party along with a decryption key to unlock the encryption supplied wallet. And at the same time the crypto buyer could be given by the escrow service an encrypted private key for the shared escrow wallet.

This way the buyer can be assured that the crypto has indeed been transferred from the seller's crypto wallet to the buyer's escrow crypto wallet as it can be seen on the blockchain for the crypto currency involved. As a result the buyer can confidently pay for the crypto funds that have been transferred and rely on the seller to subsequently send the decryption key for the buyer's escrow wallet private key upon receipt of the fiat payment to the seller from the buyer. Yet the above capability currently does not exist.

It is an object of the present invention to address or at least ameliorate some of the above disadvantages.

### NOTES

The term “comprising” (and grammatical variations thereof) is used in this specification in the inclusive sense of “having” or “including”, and not in the exclusive sense of “consisting only of”

The above discussion of the prior art in the Background of the invention, is not an admission that any information discussed therein is citable prior art or part of the common general knowledge of persons skilled in the art in any country.

### SUMMARY OF INVENTION

### Definitions

Escrow: Escrow conceptually refers to a neutral third party holding assets or access to them before they are transferred from one party in a transaction to another. In this specification the assets may be digital data. In this specification the assets may be digital data which represents an asset. The asset may be physical. The asset may be financial. The asset may be represented as a token. The asset may be represented as a token on a blockchain. The asset may be fungible or non fungible.

According to one broad form of the invention there is provided a secure cryptocurrency transfer system where a wallet is generated utilising a public and private key pair;
whereby the private key of the key pair is encrypted;
whereby the public key of the key pair and the encryption key for the private key are given to a party to a transaction;
and the other party receives the encrypted private key and the public key of the transfer wallet;
where a copy of the encrypted private key, the public key and the encryption key used to encrypt the private key are placed in storage.

According to a further broad form of the invention there is provided a data asset transfer system where a wallet is generated utilising a public and private key pair;
whereby the private key of the key pair is encrypted;
whereby the public key of the key pair and the encryption key for the private key are given to a party to a transaction;
and the other party receives the encrypted private key and the public key of the transfer wallet;
where a copy of the encrypted private key, the public key and the encryption key used to encrypt the private key are placed in storage

Preferably, the storage is only accessible to an independent party that has been invited by one or the other of the transaction parties in the event there is a dispute.

Preferably, in the event of a dispute between the two transaction participants then the mediating third party determines which party is in the wrong and delivers to them the key components they need to successfully control the transfer wallet.

Preferably, the keys stored in offline storage are deleted once the transaction has been completed.

Preferably, the storage is offline.

According to another broad form of the invention there is provided a secure cryptocurrency transfer system where a wallet is generated utilising multi-signature public keys;
where at least two private keys are generated;
where both of the private keys are required in order to transfer funds out of the transfer wallet;
whereby a single public key and one of the two private keys are given to a party to a transaction;
and the other party receives the second private key and the public key of the transfer wallet;
where a copy of the two private keys, and the public key are placed in storage.

According to another broad form of the invention there is provided a data asset transfer system where a wallet is generated utilising multi-signature public keys;
where at least two private keys are generated;
where both of the private keys are required in order to transfer funds out of the transfer wallet;
whereby a single public key and one of the two private keys are given to a party to a transaction;
and the other party receives the second private key and the public key of the transfer wallet;
where a copy of the two private keys, and the public key are placed in storage.

Preferably, the storage is only accessible to an independent party that has been invited by one or the other of the transaction parties in the event there is a dispute.

Preferably, in the event of a dispute between the two transaction participants then the mediating third party determines which party is in the wrong and delivers to them the key components they need to successfully control the transfer wallet.

Preferably, the keys stored in offline storage are deleted once the transaction has been completed.

Preferably, the storage is offline.

Preferably the data asset is digital currency.

Preferably the data asset is crypto currency.

Preferably the data asset is a token.

In a further broad form of the invention there is provided a method of controlling release of data, said method comprising:
A Set Up Step wherein
an instance of a wallet 15 has associated with access to it (to the data/funds it contains) a public key 16 and a private key 17 of a PKI key pair and also an encrypt/decrypt key 18 and wherein he encrypt/decrypt key is operable to encrypt the private key and wherein the system encrypts the private key using the encrypt/decrypt key so as to produce an encrypted private key and wherein the encrypted private key and the public key and the encryption/decryption key are stored in storage; the method further comprising
a Transaction Step wherein
In a transaction/interaction based on the set up of the instance:
Entity 1 confirms to Entity 2 receipt of public key 16 and encrypted private key 17 (encrypted using encrypt/decrypt key 18);
Entity 1 requests payment into wallet 15;
Entity 2 pays funds into the wallet 15 using the public key 16 (funds can then only be
retrieved using the private key of the key pair);
payment transaction is confirmed and recorded by the system on public crypto block chain 24, said method further comprising a Verification step 1 wherein Entity 1 sees transaction recorded on the block chain and then supplies goods/services to Entity 2 followed by a Verification step 2: Entity 2 confirms receipt of goods/services to Entity 1 whereupon Entity 2 sends encryption/decryption key 18 to Entity 1;
Entity 1 decrypts encrypted private key 17 using encryption/decryption key 18 received from Entity 2;
Entity 1 retrieves the funds from the wallet 15 using the private key 17;
Entity 2 and Entity 1 notify Entity 3 arbitrator/controller of the storage that private key 17 has been decrypted and used to access escrow wallet 15; said method further comprising
A Status Monitoring Step wherein
During the instance the wallet 15 is monitored continuously for change in status or content;
When monitoring indicates change in status/funds removed from wallet 15 then all keys 16, 17, 18 and encryptions of them for the instance are deleted from the storage;
If verification step 2 fails or is disputed Entity 3 is in a position to supply to Entity 1 or Entity 2 the private key 17 (or the decrypt/encrypt key to derive it) whereby that entity 1 or entity 2 at the election of entity 3 can retrieve the funds from wallet 15.

Preferably the data represents a digital currency.

Preferably the data represents a crypto currency.

Preferably the data is in the form of a token,

Preferably the data is in the form of a token stored on a blockchain.

According to yet another broad form of the invention there is provided a digital wallet, as is typically used in conjunction with a blockchain based cryptocurrency system, where the wallet itself and not the contained funds are escrowed by a digital third party escrow service until such times as the two parties have completed the intended transaction.

Preferably, the escrow wallet comprises at least three components being
the public key that identifies the escrow wallet,
the private key which is used to access the escrow wallet for withdrawal or transfer out of the wallet,
and a separate encryption and decryption key that is used to temporarily encrypt the private key during the escrow process.

Preferably, the public key of the escrow wallet is shared on behalf of the initiator by the escrow service with the party wishing to receive funds for payment.

Preferably, the encryption and decryption key can be a synchronous key or an asynchronous key component such as a public key pair.

### BRIEF DESCRIPTION OF DRAWINGS

Embodiments of the present invention will now be described with reference to the accompanying drawings wherein:

FIG. 1 illustrates components of an example embodiment,

FIG. 2 illustrates a flow chart of steps in the set up and implementation of an embodiment of the present invention,

FIG. 3 is a diagram of a blockchain data structure,

FIG. 4 illustrates diagrammatically use of the blockchain data structure of FIG. 3 in a form suitable to store data for the embodiments of FIG. 1 or FIG. 2.

### DESCRIPTION OF EMBODIMENTS AND OPERATION

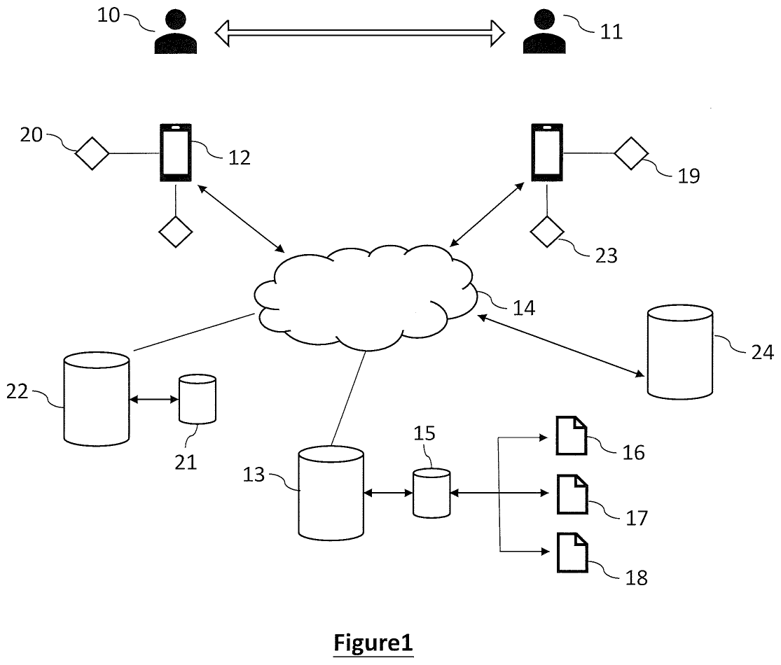

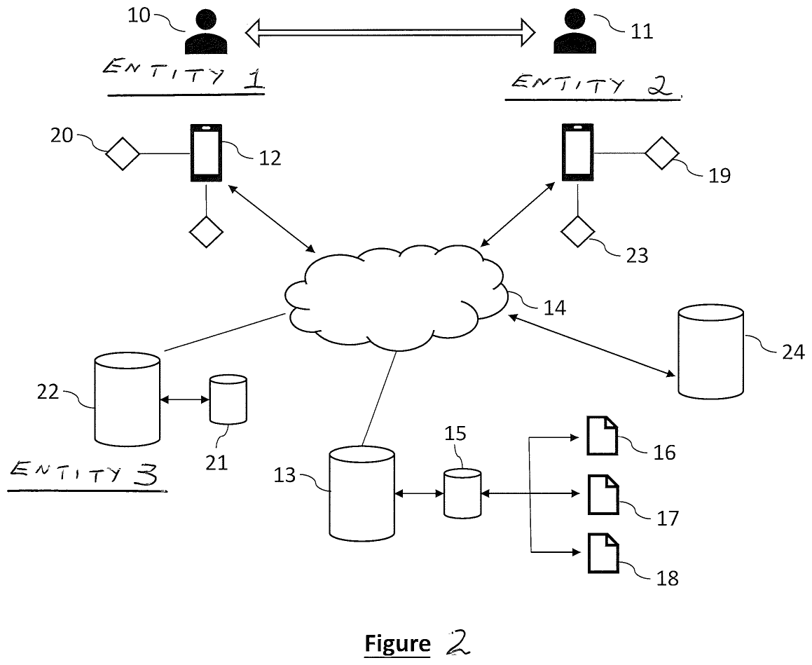

Broadly with reference to FIG. 1 and FIG. 2 in one preferred form there is disclosed a digital asset transfer system where a wallet is generated utilising a public and private key pair;
whereby the private key of the key pair is encrypted;
whereby the public key of the key pair and the encryption key for the private key are given to a party to a transaction;
and the other party receives the encrypted private key and the public key of the transfer wallet;
where a copy of the encrypted private key, the public key and the encryption key used to encrypt the private key are placed in storage.

### FIRST PREFERRED EMBODIMENT

FIG. 1 discloses the main components of an example embodiment used to provide an escrow service, which is to say a service for controlled release of data from a storage. In one form the service may be an escrow service. In a particular form the escrow may relate to digital data stored in a wallet on a block chain. In a particular form the escrow may relate to digital data representing funds stored in a wallet on a block chain.

In this embodiment an initiating user 10 wishes to transact with the responding user 11 using an escrowed transaction service.

The initiating user 10 uses their device 12 to contact the escrow service 13 by means of a public service such as the Internet 14 to obtain an escrow wallet 15.

Note that the initiating user can be a payee or a payor in this model.

During that exchange the initiating user 10 nominates both the party that is to receive funds 10 and the party that is to send funds 11 in exchange for an offered goods or service, or currency.

As part of this exchange the initiating party 10 also supplied the contact details for both parties so that the escrow service can connect securely, privately and separately with the two parties.

Typically this would be by means of a secure communications means such as an end-to-end encrypted messaging service.

The escrow wallet 15 comprises two keys as is known in the art, a public key 16 and a private key 17.

In addition an encryption key 18 is generated by the escrow service.

The encryption key is used to encrypt the private key 17 of the wallet key pair.

Typically the public key 16 of the escrow wallet is securely sent to 19 and given to the party 11 that is to pay for goods and services or currency. The payor 11.

The payor also would receive by means of secure messaging 19 the encryption/decryption key 18 for the escrow wallet private key 17 using the same secure method of communication 19 as described above.

The payor 11 also receives the public key 16 of the escrow wallet 15 by secure communication means 19.

The other party 10 who is typically the payee, is the party that is to be paid in crypto currency for the offered goods, services or currency.

The payee 10 is the sponsor of this transaction in this example embodiment and it is their intent to ensure that payment is made and confirmed as part of the process of supplying goods, services or currency.

The payee 10 is sent the escrow public key 16 and the encrypted escrow private key 17 by secure messaging 20.

Once the escrow service 13 confirms that both parties 10 11 have received their respective keys, the service places a copy of all three components 16 17 18 into offline storage 21 under the sole control of the nominated arbiter 22 of the transaction in the event there is dispute.

These keys 16 17 18 are only to be retrieved if there is a dispute of the transaction and there is need for an arbitrator 22 or moderator to work things out between the parties 10 11.

In practise this would involve the services of a professional arbitrator or a legal professional depending on the needs of the parties involved.

Once the encrypted escrow private key 17 and the escrow public key 16 are received by the pay payee 10, they 10 then notify the payor 11 that they 10 have received the escrow wallet keys 16 17 and requests that the payor 11 pay the agreed upon fee in crypto currency from their own crypto currency wallet 23 into the escrow wallet 15 that has been supplied to them in order to initiate the transaction.

At this point the payor 11 deposits funds from their own crypto currency wallet 23 into the escrow wallet 15 and the transfer is recognised and confirmed on the public crypto blockchain 24 of the corresponding crypto currency.

At this time the payee 10 will be able to see that the funds have been deposited into the escrow wallet 15 is a registered transaction on the blockchain 24 and can confidently proceed to supply the goods, services or currency that were requested by the payor 11.

Consequently the payor 11 receives the goods, services or currency and confirms with the payee 12 that the agreement has been fulfilled.

The transaction is completed when the payor 11 supplies the private key decryption key 18 to the payee 10 using a secure communications means 19 20.

Upon receipt of the decryption key 12, the payee 10 decrypts the encrypted private key 17 using the decryption key 18 and uses the decrypted private key to gain full control of the escrow wallet.

At this point the payee 10 can move or spend the contained funds at will.

Upon confirming the private key has been decrypted by the payee 10, the transaction is deemed complete and the escrow service 13 can instruct the arbitrator 22 to delete all keys 21 related to this transaction.

The escrow service 13 can independently monitor the progress of this transaction by confirming a deposit into the escrow wallet 15 on the blockchain 24, and by seeing the escrow wallet 15 being emptied by the payee 10 as the result of a transaction also recorded on the blockchain.

In the event that goods, services or currency received by the payor 11 do not meet the payor's expectation, or if the payor 11 claims that the promised goods, services or currency have not been received, one or both of the parties 10 11 can approach the escrow service 13 to initiate arbitration 22 to resolve the matter.

In the event the payor 11 receives the promised goods, services or currency but does not supply the decryption key 18 to the payee, the payor 11 can approach the escrow service 13 for arbitration 22.

In the case of arbitration 22, a third party listens to the parties involved and determines how to resolve the matter, at which time the arbitrator retrieves the transaction keys 21 from offline storage and supplies the appropriate keys to the wronged party.

### SECOND PREFERRED EMBODIMENT

With reference to FIG. 2 where like components are numbered as for the first embodiment there is shown in block diagram form a system for the controlled storage and release of data as between three entities.

The system operates as follows:

### Set Up Step

1 An instance of a wallet 15 has associated with access to it (to the data/funds it contains) a public key 16 and a private key 17 of a PKI key pair and also an encrypt/decrypt key 18. The encrypt/decrypt key is operable to (symmetrically) encrypt the private key.
2 the system encrypts the private key using the encrypt/decrypt key so as to produce an encrypted private key.
3 the encrypted private key and the public key and the encryption/decryption key are stored in storage

### Transaction Step

In a transaction/interaction based on the set up of the instance:
1 Entity 1 Payee 10 confirms to Entity 2 Payor 11 receipt of public key 16 and encrypted private key 17 (encrypted using encrypt/decrypt key 18)
2 Payee 10 requests payment into wallet 15
3 Payor 11 pays funds into the wallet 15 using the public key 16 (funds can then only be retrieved using the private key of the key pair)
4 payment transaction is confirmed and recorded by the system on public crypto block chain 24
5 Verification step 1: Payee 10 sees transaction recorded on the block chain; supplies goods/services to Payor 11
6 Verification step 2: Payor 11 confirms receipt of goods/services to payee 10
7 Payor 11 sends encryption/decryption key 18 to payee 10.
8 Payee 10 decrypts encrypted private key 17 using encryption/decryption key 18 received from Payor 11.
9 Payee retrieves the funds from the wallet 15 using the private key 17
10 Payor and Payee notify Entity 3 arbitrator/controller of the storage that private key 17 has been decrypted and used to access escrow wallet 15.

### Status Monitoring Step

11 During the instance the escrow wallet 15 is monitored continuously for change in status or content.
12 When monitoring indicates change in status/funds removed from wallet 15 then all keys 16, 17, 18 and encryptions of them for the instance are deleted from the storage.
13 If verification step 2 fails or is disputed Entity 3 is in a position to supply to party 1 or party 2 the private key 17 (or the decrypt/encrypt key to derive it) whereby that entity 1 or entity 2 at the election of entity 3 can retrieve the funds from wallet 15.

### Alternative Embodiments

The first embodiment shows the initiator being the payee of cryptocurrency funds in return for goods, services or currency that are provided by the second party.

An alternative embodiment could see the initiator of the transaction be either the payor or the payee.

A further alternative embodiment could involve multiple parties where the public key, the encrypted private key and the encryption decryption key used to encrypt the private key are allocated to any agreed party. For example multi-party decryption keys could require multiple parties to agree to allowing the private key to be decrypted before completing the transaction.

Also multi party encryptions such as Shamir's algorithm can allow unlimited parties in varying combinations to allow or disallow the transaction to proceed to completion.

The example embodiment shows secure messaging being used for the exchange of wallet and encryption keys. An alternative embodiment could use any means of communication.

The example embodiment shows a separate service or person from the escrow service from being the arbitrator during a dispute. An alternative embodiment could see anyone be the arbitrator of a dispute as long as the parties agree.

### Multi Sig Alternative Embodiment

A variation with reference to FIG. 2 where like components are numbered as for the first embodiment there is shown in block diagram form a system for the controlled storage and release of data as between three entities.

In this embodiment at least one of the three entities controls its data using multisignature (multisig) keys.

Broadly stated there is described a secure cryptocurrency transfer system where a wallet is generated utilising multi-signature public keys;
where at least two private keys are generated;
where both of the private keys are required in order to transfer funds out of the transfer wallet;
whereby a single public key and one of the two private keys are given to a party to a transaction;
and the other party receives the second private key and the public key of the transfer wallet;
where a copy of the two private keys, and the public key are placed in storage.

The example embodiment discloses an escrow wallet with a single key pair where the private key is encrypted and given to the receiver of the wallet and the decryption code for that key is given to the giver of the wallet and where the keys and the decryption code are sent to an offline storage facility for retrieval by a pre agreed arbitrator in the event there is dispute between the two parties.

An alternative embodiment could see the use of a multi-sig wallet to be used in place of a single key pair wallet.

In this embodiment a wallet is generated with one public key and two private keys using a wallet rule where both keys are needed in order to move funds out of the wallet.

In this situation the first private key and the public key are given to the sender of the funds. The other second private key and the public key are given to the receiver of the escrow wallet. Then a copy of both private keys as well as the public key are sent to offline storage for retrieval by an arbitrator in the event of a dispute between the two parties.

Typically this arrangement would be used where there is an exchange of goods or services where a cryptocurrency is being used as payment. In such a transaction, the seller of the goods would receive one of the private keys and the public key and the buyer of the goods would also receive a public key and the second private key.

The buyer would use the escrow wallet to make payment and to prove the availability of funds, then the seller of the traded goods or services could verify funds have been provided, then confidently provide the goods or services. Once the buyer receives the goods or services they can verify that they are delivered as promised and then release to the seller their second private key so that the seller can obtain full control of the wallet.

In the event a dispute arises, the arbitrator can be invoked and a decision made as to how to resolve matters and then the arbitrator can retrieve the two private keys from offline storage and give the appropriate corresponding key to the wronged party.

This would therefore enable the seller of goods to be paid for their goods or services, or for the buyer to return the goods or services and then have their funds returned to them by the arbitrator by being issued with the sellers private key.

### Block Chain Structures

Blockchain structures may be used to advantage with any of the above described embodiments to store the data. In one form this includes data stored in wallet 15.

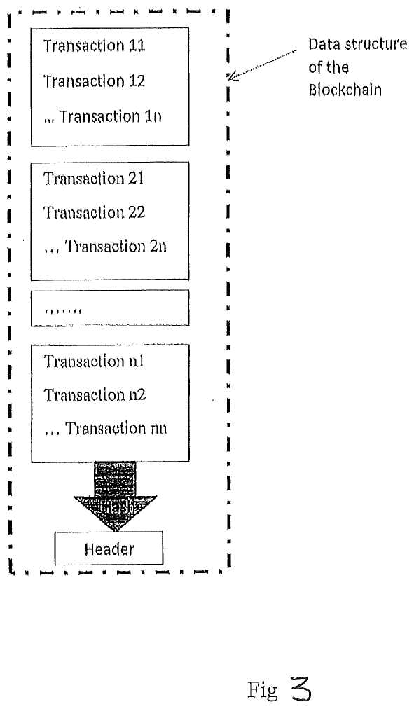

FIG. 3 is a diagram of an exemplary block chain data structure

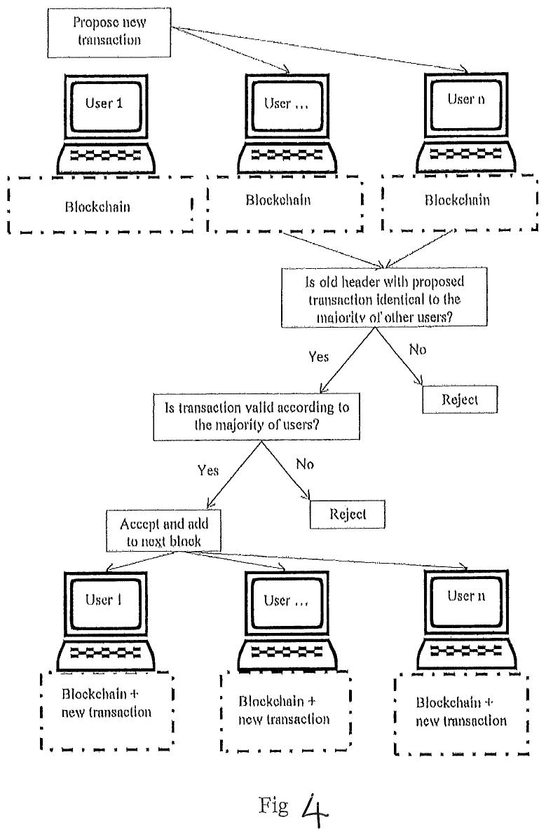

FIG. 4 illustrates diagrammatically use of the block chain data structure of FIG. 3.

With reference to FIGS. 3 and 4, Blockchain is a data structure and distributed record system, which seeks to provide a data structure and system which maintains a complete record of all transactions and minimizes risk of retrospective alterations, or double or identical transactions.

The data structure consists of a series of transactions grouped in blocks, which need to be verified before they are added to the chain. Rules may be set so no data is ever deleted, with the longest chain being taken to be the most recent, and so the chain records all transactions from its initiation in chronological order.

A copy of the chain is kept by all users, and so is a distributed record system. Before any transactions are added the majority of the users need to agree that the transaction is acceptable and then it is bundled with other acceptable transactions into a block, which is added to the chain. Each block has a header which can only be created knowing all the previous transactions. As a result, if a retrospective alteration is made the header will be incorrect and any new block proposed by that user will be rejected. The security of the system is further enhanced by having mathematical problems that can only be solved by trial and error, which use the header and must be solved and then verified by the majority of other users before a block is accepted into the chain by all users. As long as there are more genuine users than coordinated attackers trying to alter the chain then the chain will be secure. There may be other methods used to determine the veracity of a block of data, this may include voting or consent processes where parties with a stake in the transaction or related transactions or in the chain itself are granted ‘voting’ rights. Another process may involve a random or systematized voting or approval system where the validity of the block of data is approved in accordance with a set of protocols agreed by those with a stake in the veracity of the chain of data.

In a more particular form, each block includes verified transactions and the blockchain maintains a ledger all prior transactions. The blockchain is duplicated by all the computers on a network.

The first block in the chain is known as the Genesis block and new blocks can be added in linear and chronological order. From any given block in the chain the information of this genesis block and all blocks that led back to this one can be retrieved. A blockchain is essentially numerous blocks connected through hash chaining where each block is comprised of the following
Timestamp: provides proof that the data in a block existed at a particular time
Previous Hash: Essentially a pointer to the previous block
Merkle Hash: Summary of all executed transactions
Nonce: Individual blocks identity and is an arbitrary number which can only be used once

The blockchain is managed by a network of distributed nodes where each node contains a copy of the entire blockchain. Each node in the network can add blocks to the chain, where every node is adding blocks at the same point in the chain at the same time. The more nodes that comprise the network the harder it is to disrupt the storage of the blockchain. Unlike centralised systems which rely on a single authority, there is no single point of failure in these distributed nodes network. If you change the content of a block you change its Hash.

The above describes only some embodiments of the present invention and modifications, obvious to those skilled in the art, can be made thereto without departing from the scope of the present invention.

### INDUSTRIAL APPLICABILITY

Embodiments of the present invention are applicable to the storage of data and the control of data and more particularly to the controlled release of data,

In some instances the data may represent an identifier of an asset. In some instances the asset may be a physical asset. In some instances the asset may be a financial asset.

In a particular form embodiments of the invention may be implemented as an escrow system.

1. A secure data asset transfer system where a wallet is generated utilising a public and private key pair;
whereby the private key of the key pair is encrypted;
whereby the public key of the key pair and the encryption key for the private key are given to a party to a transaction;
and the other party receives the encrypted private key and the public key of the transfer wallet;
where a copy of the encrypted private key, the public key and the encryption key used to encrypt the private key are placed in storage.

2. The transfer system of claim 1, wherein the storage is only accessible to an independent party that has been invited by one or the other of the transaction parties in the event there is a dispute.

3. The transfer system of claim 1, whereby in the event of a dispute between the two transaction participants then the mediating third party determines which party is in the wrong and delivers to them the key components they need to successfully control the transfer wallet.

4. The transfer system of claim 1, whereby the keys stored in offline storage are deleted once the transaction has been completed.

5. The transfer system of claim 1, wherein the storage is offline.

6. A secure data asset transfer system where a wallet is generated utilising multi-signature public keys;
where at least two private keys are generated;
where both of the private keys are required in order to transfer funds out of the transfer wallet;
whereby a single public key and one of the two private keys are given to a party to a transaction;
and the other party receives the second private key and the public key of the transfer wallet;
where a copy of the two private keys, and the public key are placed in storage.

7. The transfer system of claim 6, wherein the storage is only accessible to an independent party that has been invited by one or the other of the transaction parties in the event there is a dispute.

8. The transfer system of claim 6, whereby in the event of a dispute between the two transaction participants then the mediating third party determines which party is in the wrong and delivers to them the key components they need to successfully control the transfer wallet.

9. The transfer system of claim 6, whereby the keys stored in offline storage are deleted once the transaction has been completed.

10. The transfer system of claim 6, wherein the storage is offline.

11. The system of claim 6 wherein the data asset is digital currency.

12. The system of claim 11 wherein the data asset is crypto-currency.

13. The system of claim 6 wherein the data asset is a token.

14. A method of controlling release of data, said method comprising:
A Set Up Step wherein an instance of a wallet 15 has associated with access to it (to the data/funds it contains) a public key 16 and a private key 17 of a PKI key pair and also an encrypt/decrypt key 18 and wherein the encrypt/decrypt key is operable to encrypt the private key and wherein the system encrypts the private key using the encrypt/decrypt key so as to produce an encrypted private key and wherein the encrypted private key and the public key and the encryption/decryption key are stored in storage-; the method further comprising a Transaction Step wherein
In a transaction/interaction based on the set up of the instance:
Entity 1 confirms to Entity 2 receipt of public key 16 and encrypted private key 17 (encrypted using encrypt/decrypt key 18);
Entity 1 requests payment into wallet 15;
Entity 2 pays funds into the wallet 15 using the public key 16 (funds can then only be retrieved using the private key of the key pair);
payment transaction is confirmed and recorded by the system on public crypto block chain 24, said method further comprising a Verification step 1 wherein Entity 1 sees transaction recorded on the block chain and then supplies goods/services to Entity 2 followed by a Verification step 2:
Entity 2 confirms receipt of goods/services to Entity 1 whereupon Entity 2 sends encryption/decryption key 18 to Entity 1;
Entity 1 decrypts encrypted private key 17 using encryption/decryption key 18 received from Entity 2;
Entity 1 retrieves the funds from the wallet 15 using the private key 17;
Entity 2 and Entity 1 notify Entity 3 arbitrator/controller of the storage that private key 17 has been decrypted and used to access escrow wallet 15; said method further comprising a
Status Monitoring Step wherein
During the instance the wallet 15 is monitored continuously for change in status or content;
When monitoring indicates change in status/funds removed from wallet 15 then all keys 16, 17, 18 and encryptions of them for the instance are deleted from the storage;
If verification step 2 fails or is disputed, Entity 3 is in a position to supply to Entity 1 or Entity 2 the private key 17 (or the decrypt/encrypt key to derive it) whereby that entity 1 or entity 2 at the election of entity 3 can retrieve the funds from wallet 15.
